(19) United States
(12) Patent Application Publication
(10) Pub. No.: US 2026/0010630 A1
(43) Pub. Date: Jan. 8, 2026

(54) APPARATUS FOR PROVIDING MANAGEMENT FUNCTION

(71) Applicant: Hitachi Vantara, Ltd., Yokohama-shi (JP)

(72) Inventors: Keiichi WATANABE, Tokyo (JP); Shinya TAKEUCHI, Tokyo (JP)

(21) Appl. No.: 19/074,540

(22) Filed: Mar. 10, 2025

(30) Foreign Application Priority Data
Jul. 5, 2024 (JP) 2024-109021

(51) Int. Cl. G06F 21/57; G06F 8/65

(52) U.S. Cl. CPC G06F 21/572; G06F 8/65; G06F 2221/033

(57) ABSTRACT

An apparatus for providing a management function includes a processor and a memory device. The memory device stores therein agent software capable of executing a plurality of management functions for managing the apparatus, and also stores consent information indicating whether use of each of the plurality of management functions is permitted The processor executes a management function use of which is permitted by the consent information, among the plurality of management functions, and rejects execution of a management function use of which is prohibited by the consent information. The processor updates the agent software without obtaining a consent of the administrator of the apparatus.

### CLAIM OF PRIORITY

The present application claims priority from Japanese patent application JP 2024-109021 filed on Jul. 5, 2024, the content of which is hereby incorporated by reference into this application.

### BACKGROUND OF THE INVENTION

### 1. Field of the Invention

The present invention relates to management of the functions of an apparatus.

### 2. Description of the Related Art

As a related art of the present application, there is JP 2023-146741 A. JP 2023-146741 A discloses a method for updating software on a monitoring device depending on how the monitoring device is used. Specifically, in a monitoring device configured to monitor a network device that is a device to be managed in a device management service and to execute software that operates in a different operation mode depending on how the monitoring device is used, when an update related to the software becomes necessary, the monitoring device compares the version of a license agreement pertinent to the update and associated with the way in which the monitoring apparatus is currently being used, with the current version of the license agreement, and executes the software-related update when the versions match (see summary).

### SUMMARY OF THE INVENTION

Conventionally, apparatuses are designed to prompt a user to give a consent to a license agreement before updating a function of a piece of software. Generally, the software running on the apparatus cannot be updated unless the consent is obtained. If such software includes an item that cannot be consented due to the operation policy enforced by an administrator of the apparatus, such an item becomes an obstacle of the software update. With the technology described above, the software is not updated until a consent is obtained. Therefore, software update of the apparatus may be put behind.

An aspect of the present invention is an apparatus for providing a management function, the apparatus comprising: a processor; and a memory device, in which the memory device stores agent software capable of executing a plurality of the management functions of the apparatus, and also stores consent information indicating whether use of each of the plurality of management functions is permitted, and the processor executes a management function use of which is permitted by the consent information, among the plurality of management functions, rejects execution of a management function use of which is prohibited by the consent information, and updates the agent software without obtaining a consent of an administrator of the apparatus.

According to one aspect of the present invention, software can be updated in a timely manner while ensuring compliance to the operation policies of the apparatus.

### BRIEF DESCRIPTION OF THE DRAWINGS

FIG. 1 illustrates an example of a logical configuration of a system according to one embodiment of the present disclosure;

FIG. 2 illustrates an example of a logical configuration of a cloud service device that provides a cloud service;

FIG. 3 illustrates an example of a logical configuration of a storage apparatus;

FIG. 4 illustrates an example of a hardware configuration of a computer;

FIG. 5 illustrates an example of a configuration of an affiliation-managed apparatus table;

FIG. 6 illustrates an example of a configuration of a pass-down apparatus management table;

FIG. 7 illustrates an example of a configuration of a consent status table;

FIG. 8 illustrates an example of a configuration of a user information table;

FIG. 9 illustrates an example of a configuration of a presented-name-to-function mapping table stored in the storage apparatus;

FIG. 10 illustrates an example of a configuration of a per-function consent management table stored in the storage apparatus;

FIG. 11 illustrates an example of a configuration of consent pass-down setting stored in the storage apparatus;

FIG. 12 illustrates an example of a configuration of trust information setting stored in the storage apparatus;

FIG. 13 illustrates an example of a trust information setting sequence in the storage apparatus;

FIG. 14 illustrates an example of a trust information verification sequence in the storage apparatus;

FIG. 15 illustrates an example of a sequence of a process of transmitting storage apparatus data from the storage apparatus to the cloud service;

FIG. 16 illustrates an example of a sequence of a storage apparatus changing process;

FIG. 17 illustrates an example of a sequence of a trust information updating process;

FIG. 18 illustrates an example of an agent software updating sequence in the storage apparatus;

FIG. 19 illustrates an example of a consent pass-down status updating sequence in the storage apparatus;

FIG. 20 illustrates an example of an originator candidate apparatus list providing sequence in the cloud service;

FIG. 21 illustrates an example of a consent status changing sequence in the cloud service;

FIG. 22 illustrates an example of a consent status providing sequence in the cloud service;

FIG. 23 illustrates an example of a trust information providing sequence in the cloud service;

FIG. 24 illustrates an example of a service screen displayed on the management terminal by a storage management service;

FIG. 25 illustrates an example of the service screen displayed on the management terminal by the storage management service;

FIG. 26 illustrates an example of a trust information updating screen;

FIG. 27A illustrates an example of a cloud service screen presented by a cloud service to a user; and

FIG. 27B illustrates an example of a cloud service screen presented to the user by the cloud service.

### DESCRIPTION OF THE PREFERRED EMBODIMENTS

An embodiment of the present disclosure will now be explained with reference to the accompanying drawings. Among the accompanying drawings, elements having the same functions are sometimes denoted by the same reference numerals. Note that, although the accompanying drawings illustrate specific examples and implementation examples conforming to the principles of the present invention, these drawings are intended to facilitate understanding of the present invention, and are never to be used as a limitation in interpretations of the present invention.

The embodiment of the present disclosure will be described in sufficient details for allowing those skilled in the art to implement the present invention; however, it should be understood that implementations and embodiments other than those described herein are still possible, and changes in the configurations and the structures and replacements of various elements are also possible without deviating from the scope and the spirit of the technical idea of the present invention. Therefore, interpretations of the following description should not be limited thereto.

Further, the embodiment disclosed herein may be implemented as software running on a processor, dedicated hardware, or a combination of software and hardware. In the description of processing according to the embodiment of the present disclosure using “each processing unit as a program” as the subject of the sentence (the subject of an operation), the subject of the description may also be a processor, because such a program performs predetermined processing by being executed by a processor (e.g., CPU), using a memory and a communication port (communication control device).

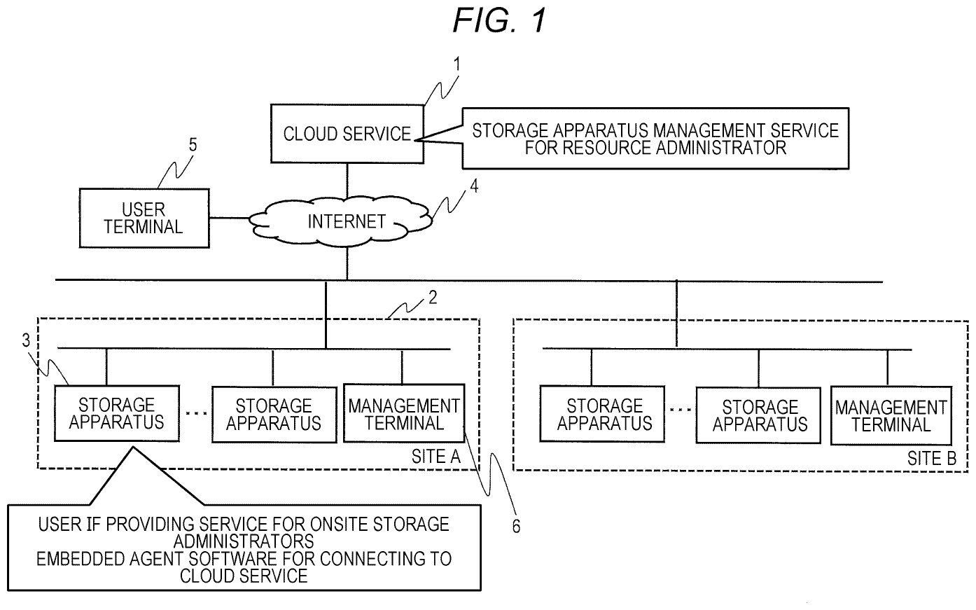

FIG. 1 illustrates an example of a logical configuration of a system according to one embodiment of the present disclosure. Note that illustrated in FIG. 1 is merely one example, and each component may be provided in any number, and some of the components may be omitted therefrom, or any other components may be added thereto.

A cloud service 1 provides a resource administrator (user) with a service for managing a storage apparatus 3. The user accesses the cloud service 1 via the Internet 4 from a user terminal 5.

In the exemplary configuration illustrated in FIG. 1, the cloud service 1 provides a service for managing storage apparatuses 3 at two sites 2. In each of such sites 2, a plurality of storage apparatuses 3 and a management terminal 6 are connected over a network such as a local area network (LAN). In FIG. 1, reference numerals are given to a site A that is one of the sites, one of the storage apparatuses, and one of the management terminals, as an example. The network in each of the sites 2 is connected to the Internet 4.

The storage apparatus 3 executes a user IF providing service for on-site storage administrators, and embedded agent software for connecting to the cloud service. The storage administrator manages the storage apparatus 3 using the management terminal 6. The storage apparatus 3 is an example of an information apparatus or an IoT device. Features of the embodiment of the present disclosure may be applied to any information apparatus or IoT device of a type different from the storage apparatus 3.

When the storage apparatus 3 downloads the agent software, a consent form and a list of functions of the agent software are also downloaded from the cloud service 1. In the consent form, the storage administrator selects a function of the agent software, that is, a function of the storage apparatus 3 permitted to use from the cloud, by making an operation on the storage apparatus 3. Such a selection of a function may include an update of a past selection.

The agent software on the storage apparatus 3 controls requests from the cloud service 1, on the basis of a scope consented by the storage administrator and the list of the functions. Given the consenting operation of the storage administrator, the storage apparatus 3 gives the cloud a permission to execute only the functions within the consent, upon being requested by the cloud.

The latest update (software update) is automatically applied to the agent software on the storage apparatus 3 through the interoperation with the cloud service 1, without obtaining the consent of the storage administrator. In this manner, updates satisfying minimum requirements, such as defect fix or a security patch not requiring any consent can be applied automatically in a timely fashion.

The agent software on the storage apparatus 3 can be updated at an any timing, and the agent software operates within the scope consented by the storage administrator. It is thus ensured that the storage apparatus 3 operates on the basis of the license agreement consented in the past. Even when no consent has been made on the use of some of the functions of the agent software, the storage apparatus 3 can always keep the agent software updated to the latest condition, while operating in accordance with the existing consent.

In one embodiment of the present disclosure, the cloud service 1 acquires information on the scope consented on each of the storage apparatuses 3 from that storage apparatus 3, and retains the information. The cloud service 1 refers to this information, and imposes restrictions on the functions to be provided to the users of the cloud service 1. In this manner, restrictions can be imposed on the monitoring and the management functions of the storage apparatus 3 made available via the cloud service 1, in accordance with the scope consented on each of the storage apparatuses 3. Note that control of the function imposed by the cloud service 1 may be omitted.

The cloud service 1 prohibits users from making operations on the management functions not given a consent for use, among the various management functions of the storage apparatus 3. For example, when a function not given a consent has been selected by the user, the cloud service 1 may display an error on the user terminal 5. In another example, the cloud service 1 may omit displaying the function not given a consent for use, on the user terminal 5, so as to disable the user from selecting the function. In this manner, it is possible to omit processing performed in response to a user selecting an unpermitted function.

In one embodiment of the present disclosure, a consent as to whether the functions are permitted to use are passed down to a storage apparatus 3 from another storage apparatus 3. In this manner, when a large number of storage apparatuses 3 are being managed, the consented scope can be set and changed all at once. Thus, management cost can be reduced.

At the time of receiving the function-related consent, the storage apparatus 3 also receives a selection of a storage apparatus serving as an originator from which the consented scope is passed down, from the storage administrator. On the originator storage apparatus, consent for the use of the functions is already given. Once the originator storage apparatus is designated, the storage apparatus 3 registers the scope having already been consented on the originator, to the storage apparatus 3 itself. When there is a change in the consented scope on the originator, the storage apparatus 3 automatically updates the consented scope registered therein in the same manner, without any operation of the storage administrator.

Information on which storage apparatuses are permitted to become the originator is retained in the cloud service 1. The storage apparatus 3 may present storage apparatuses that are originator candidate storage apparatus, in the consent form, and receive a selection from the storage administrator. A relationship in which the consented scope is passed down is also retained in the cloud service 1. When a change is made in the consented scope on the originator, the cloud service 1 can provide the information to the recipient to cause the recipient to update the consented scope.

In one embodiment of the present disclosure, a setting of a trusted entity permitted to use a function is provided, and a change in the consented scope resulting from a change in the trusted entity is managed. Examples of information on which the trust is based (trust information) include the name of a service, a user, and the privilege of the user. The information on which the trust is based is embedded in the consent form, and the storage administrator can specify on what basis the trust relationship with the cloud service is to be established. The consented scope defines how the agent software behaves when there is a change in the trusted entity (trust relationship). Specifically, the consented scope defines the functions use of which is permitted when there is a change in the trusted entity.

For example, the cloud service 1 notifies the agent software in the storage apparatus 3 of information on which the trust is based, regularly or at the time when there is an update in the information. When there is a change in the information on which the trust is based, the agent software controls the functions on the basis of settings of the trust relationship. In this manner, it is possible to enhance the security of operations managing the storage apparatus 3 over the cloud.

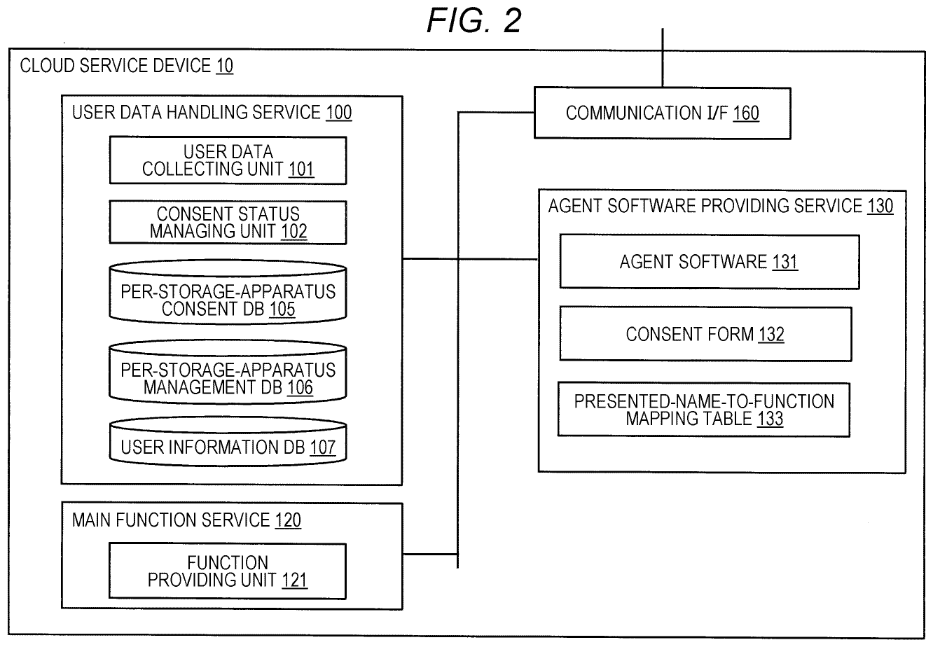

FIG. 2 illustrates an example of a logical configuration of a cloud service device 10 providing the cloud service 1. The cloud service device 10 may include one or more computers. In the exemplary configuration illustrated in FIG. 2, the cloud service 1 includes a user data handling service 100, a main function service 120, an agent software providing service 130, and a communication interface 160.

The user data handling service 100 includes a user data collecting unit 101 and a consent status managing unit 102. The user data handling service 100 includes a per-storage-apparatus consent database (DB) 105, a storage apparatus management database 106, and a user information database 107.

The user data collecting unit 101 collects data on the users of the cloud service 1. The consent status managing unit 102 manages information pertinent to the consent of the storage administrator, in relation to consent given for the use of functions of the agent software installed in the storage apparatus 3. The information stored in the databases 105 to 107 will be described later.

The main function service 120 includes a function providing unit 121. The function providing unit 121 enables the users to make a specific storage management operation, using the agent software installed in the storage apparatus 3. For example, the function providing unit 121 can present information received from the agent software in the storage apparatus 3 to the user, or instruct the agent software in the storage apparatus 3 to change a configuration in accordance with an instruction from the user.

The agent software providing service 130 includes agent software 131, a consent form 132, and a presented-name-to-function mapping table 133. The agent software 131 is installed in the storage apparatus 3, and provides various functions for managing the storage apparatus 3. For example, one piece of agent software 131 is implemented on one storage apparatus 3. The function of the agent software 131 is limited by the scope consented by the storage administrator.

The consent form 132 stores therein a consent form concerning the use of functions, the consent form being received from each of the storage apparatuses 3. The presented-name-to-function mapping table 133 manages a relationship between a function executed by the agent software in the storage apparatus 3 and the name of the function used in the consent form. Details thereof will be described later.

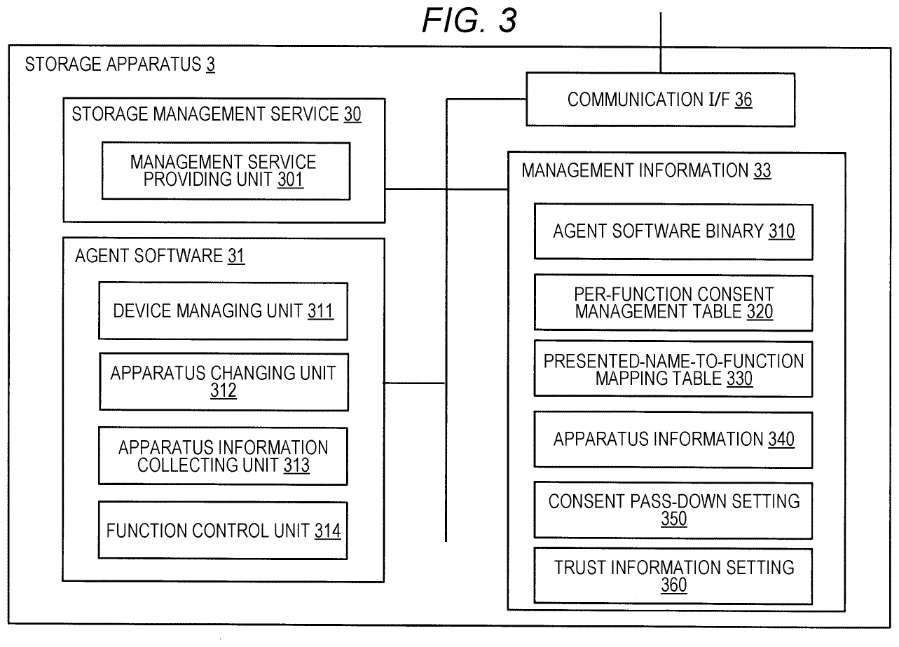

FIG. 3 illustrates an example of a configuration of the storage apparatus 3. The storage apparatus 3 includes a storage management service 30, agent software 31, management information 33, and a communication interface 136. The storage management service 30 includes a management service providing unit 301. The management service providing unit 301 manages information for processing performed by the agent software 31, for example.

The agent software 31 is downloaded from the cloud service device 10 and installed in the storage apparatus 3. The agent software 31 provides storage management functions for users of the cloud service. For example, the agent software 31 can provide information in the storage apparatus 3 to the cloud service 1, or change the configuration of the storage apparatus 3 in response to an instruction from the cloud service 1. In the exemplary configuration illustrated in FIG. 3, the agent software 31 includes a device managing unit 311, an apparatus changing unit 312, an apparatus information collecting unit 313, and a function control unit 314.

The management information 33 includes an agent software binary 310, a per-function consent management table 320, a presented-name-to-function mapping table 330, apparatus information 340, a consent pass-down setting 350, and a trust information setting 360. The agent software binary 310 is a program downloaded from the cloud service device 10, and a program being executed is the agent software 31. The apparatus information 340 includes information such as configuration information and operation status information inside the storage apparatus 3.

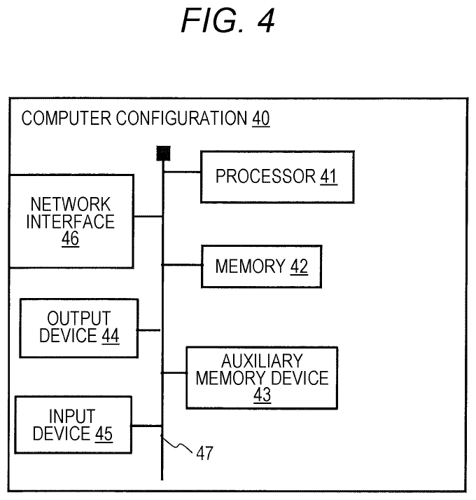

An exemplary hardware configuration of a computer will now be explained with reference to FIG. 4. Referring to FIG. 1, the cloud service device 10, the storage apparatus 3, the user terminal 5, and the management terminal 6 may have similar configurations. The computer configuration 40 includes a CPU (processor) 41 that executes various programs, a memory (main memory device) 42 that stores therein various programs, and an auxiliary memory device 43 that stores therein various data. The processor 41 may include one or more cores, and the memory 42 is a DRAM including a volatile storage area, for example. The auxiliary memory device 43 is a hard disk drive (HDD) or a flash memory, for example, and can provide a non-volatile storage area.

The computer configuration 40 further includes an output device 44 for presenting information to a user of the device, an input device 45 for receiving an instruction, an image, or the like entered by the user, and a network interface 46 for communicating with another device. These units are connected to one another via a bus 47. The user may use a user terminal 51 connected to the computer configuration 40 via a network, instead of the input device and the output device provided to the computer configuration 40.

The functional units of the computer configuration 40 can be implemented by causing the processor 41 to operate in accordance with a program, for example. The processor 41 reads various programs from the memory 42, and executes the programs, as necessary. The memory 42 can store programs and data used by the programs. Each program and reference data are loaded from the auxiliary memory device 43 onto the memory 42, for example, and are executed and processed by the processor 41. At least a part of the functional units may be configured as a logic circuit.

The output device 44 includes devices such as a display, a printer, and a speaker. The input device 45 includes devices such as a keyboard, a mouse, and a microphone. The output device 44 presents a result entered by the user, and presents a result processed by the computer configuration 40. The input device 45 inputs any instruction given by the user to the computer configuration 40.

The network interface 206 receives, for example, data transmitted from another device connected thereto over a network, and transmits a result processed by the computer configuration 40 to another device.

The storage apparatus 3 may include a plurality of storage drives for storing user data in the auxiliary memory device 43. Examples of the storage drive includes a hard disk drive and a flash memory drive. The storage apparatus 3 may also include a back-end interface for allowing plurality of storage drives to communicate with the processor 41 and the memory 42, as well as an accelerator for performing specific data processing. Each of these components may be included in any number, and some of these devices may be omitted. For example, in a device accessed from a terminal over a network, such as the cloud service device 10 or the storage apparatus 3, the output device 204 and the input device 255 may be omitted.

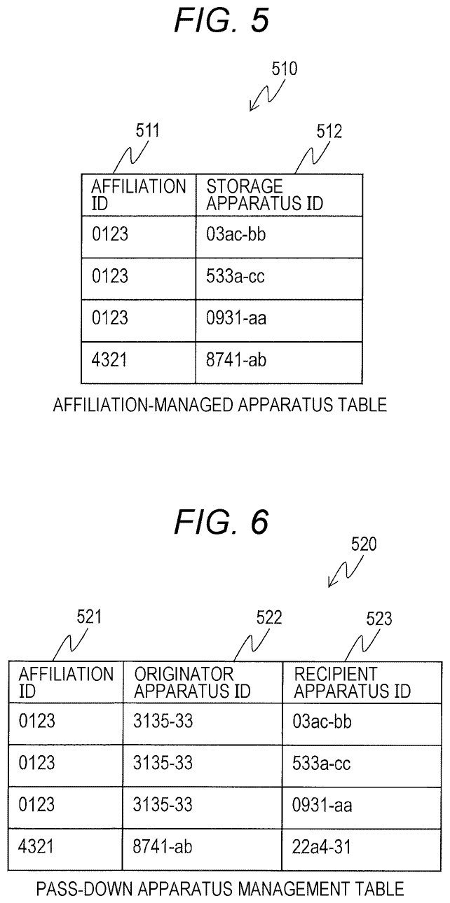

FIG. 5 illustrates an example of a configuration of an affiliation-managed apparatus table 510. The affiliation-managed apparatus table 510 is stored in the storage apparatus management database 106 in the cloud service device 10. The affiliation-managed apparatus table 510 manages an affiliation of the storage apparatus 3. The affiliation may be, for example, a company or a department where the storage apparatus 3 is used. The cloud service 1 is managed and provided in units of the affiliation. The storage apparatus 3 may be managed in units of an affiliation. In the exemplary configuration illustrated in FIG. 5, the affiliation-managed apparatus table 510 includes an affiliation ID field 511 and a storage apparatus ID field 512. The affiliation ID field 511 specifies the ID of the affiliation of a storage apparatus 3, and the storage apparatus ID field 512 specifies the ID of the storage apparatus 3.

FIG. 6 illustrates an example of a configuration of a pass-down apparatus management table 520. The pass-down apparatus management table 520 is stored in the per-storage-apparatus consent database 105 in the cloud service device 10. The pass-down apparatus management table 520 manages a relationship between the originator and the recipient of a consented list indicating whether the use of the functions of the agent software 31 via the cloud service 1 is permitted.

The agent software 31 on the recipient storage apparatus 3 shares the consented scope with the agent software 31 on the originator storage apparatus 3. Any change in the consented scope on the originator is automatically reflected to the consented scope on the recipient. In this manner, management of apparatuses are aided.

In the exemplary configuration illustrated in FIG. 6, the pass-down apparatus management table 520 includes an affiliation ID field 521, an originator apparatus ID field 522, and a recipient apparatus ID field 523. The affiliation ID field 521 specifies the ID of the affiliation of storage apparatuses 3. The originator apparatus ID field 522 and the recipient apparatus ID field 523 specify the IDs of the originator and the recipient storage apparatuses 3, respectively. In the exemplary configuration illustrated in FIG. 6, the affiliation of the originator and the recipient are the same, and one apparatus may be the originator for one or more recipients. Note that the relationship between the originator and the recipient is not limited to the exemplary configuration illustrated in FIG. 6.

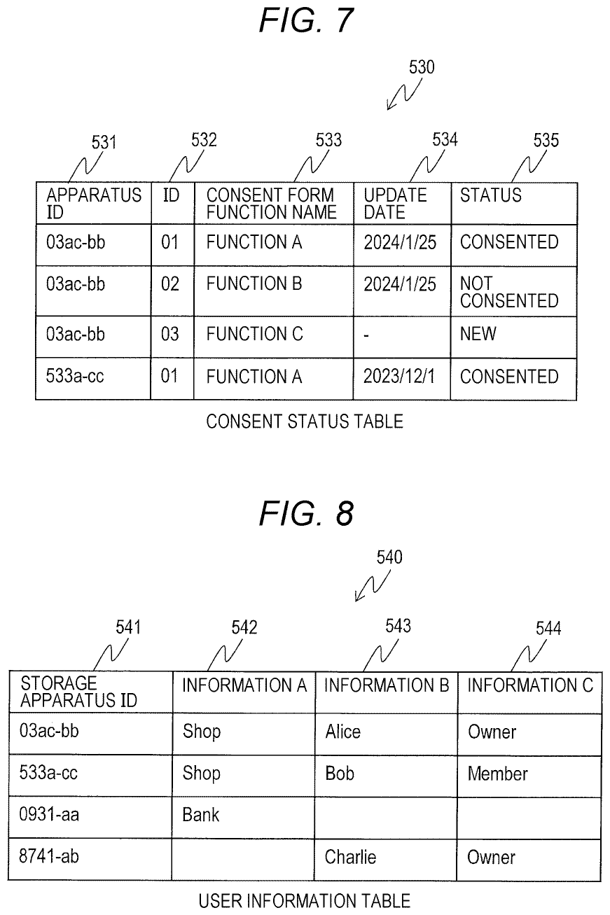

FIG. 7 illustrates an example of a configuration of a consent status table 530. The consent status table 530 is stored in the per-storage-apparatus consent database 105 in the cloud service device 10. The consent status table 530 manages a list of the functions the use of which is permitted, the functions being those of the agent software 31 on each of the storage apparatuses 3.

In the exemplary configuration of FIG. 7, the consent status table 530 includes an apparatus ID field 531, an ID field 532, a consent form function name field 533, an update date field 534, and a status field 535. The apparatus ID field 531 specifies the ID of a storage apparatus 3. The ID field 532 specifies the ID of a function of the agent software 31 on each of the storage apparatuses 3. The consent form function name field 533 specifies the name of a function of the agent software 31, the name being included in a consent form to be consented by the storage administrator. The update date field 534 specifies the date on which the status is updated. The status field 535 specifies whether a consent has been obtained for the use of the function. “New” specifies that any consent for use, which is given by the storage apparatus administrator, has not been registered for a newly added function.

FIG. 8 illustrates an example of a configuration of a user information table 540. The user information table 540 is stored in the user information database 107 in the cloud service device 10, and updated by the user data collecting unit 101. The user information table 540 manages users of the cloud service 1, and manages information of a user having a trust relationship with each of the storage apparatuses 3. A change in the user information may result in a change in the functions of the storage apparatus 3 permitted to use.

In the exemplary configuration illustrated in FIG. 8, the user information table 540 includes a storage apparatus ID field 541, an information A field 542, an information B field 543, and an information C field 544. The storage apparatus ID field 541 specifies the ID of a storage apparatus 3. The information A field 542 specifies the name of a cloud service. The information B field 543 specifies the name of a user of the cloud service, and the information C field 544 specifies the privilege given to the user.

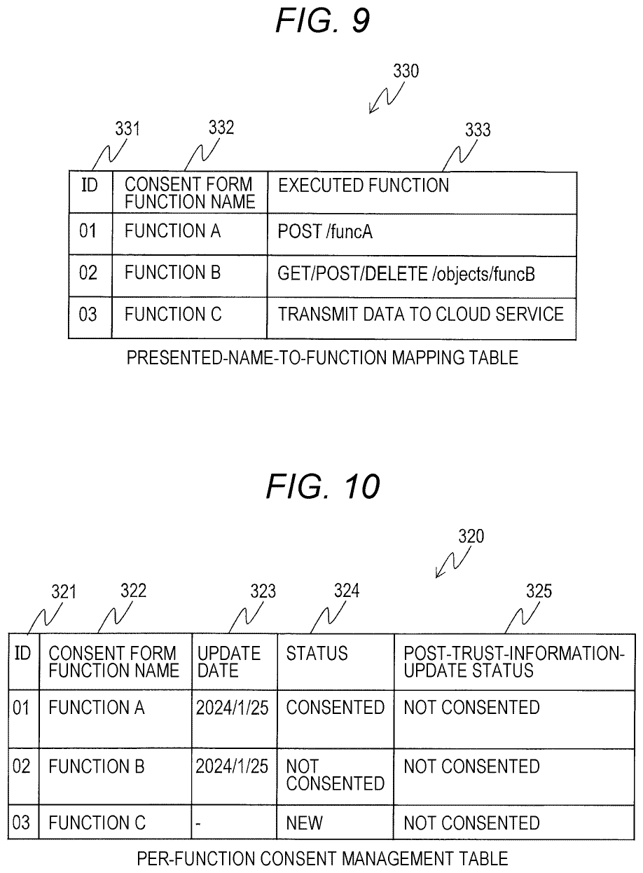

FIG. 9 illustrates an example of a configuration of the presented-name-to-function mapping table 330 stored in the storage apparatus 3. The presented-name-to-function mapping table 330 specifies a relationship between a function executed by the agent software 31 in the storage apparatus 3, and the name of the function of the agent software 31 used in the consent form to be consented by the storage administrator. In the exemplary configuration illustrated in FIG. 9, the presented-name-to-function mapping table 330 specifies an ID field 331, a consent form function name field 332, and an executed function field 333. The ID field 331 specifies the ID of a function. The consent form function name field 332 and the executed function field 333 specify the name of the function used in the consent form, and the function executed in the storage apparatus 3, respectively.

FIG. 10 illustrates an example of a configuration of the per-function consent management table 320 stored in the storage apparatus 3. The per-function consent management table 320 manages the presence of a consent pertinent to the use of a function of the agent software 31 executed by a storage apparatus 3. In the exemplary configuration illustrated in FIG. 10, the per-function consent management table 320 includes an ID field 321, a consent form function name field 322, an update date field 323, a status field 324, and a post-trust-information-update status field 325. The fields 321 to 324 correspond to the fields 532 to 535 of the consent status table 430, respectively.

The ID field 321 specifies the ID of a function of the agent software 31. The consent form function name field 322 specifies the name of the function of the agent software 31, used in the consent form. The update date field 323 specifies the date on which information related to the consent is updated. The status field 324 specifies the whether a consent has been obtained for the use of the function. The post-trust-information-update status field 325 specifies whether to permit, when there is a change in the user information, the use of the functions of the storage apparatus 3 via the cloud service having a trust relationship with the storage apparatus 3.

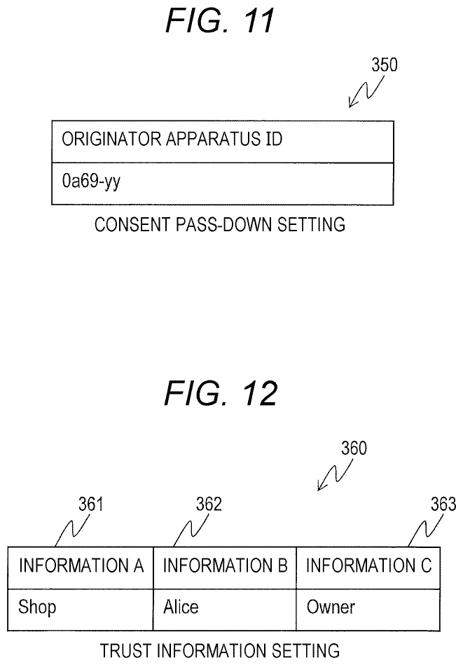

FIG. 11 illustrates an example of a configuration of the consent pass-down setting 350 stored in the storage apparatus 3. The consent pass-down setting 350 specifies the ID of the originator storage apparatus 3 from which the consented scope of use is passed down.

FIG. 12 illustrates an example of a configuration of the trust information setting 360 stored in the storage apparatus 3. The trust information setting 360 specifies information of a user of the cloud service 1, using the storage apparatus 3 and having a trust relationship. In the exemplary configuration of FIG. 12, the trust information setting 360 includes an information A field 361, an information B field 362, and an information C field 363. The information A field 361 specifies the name of a cloud service. The information B field 362 specifies the name of a user of the cloud service, and the information C field 363 specifies the privilege given to the user. These fields correspond to the fields 542 to 544 of the user information table 540, respectively. As will be described later, the trust information setting 360 stores therein information of an item selected by the storage administrator, without storing therein the information not selected.

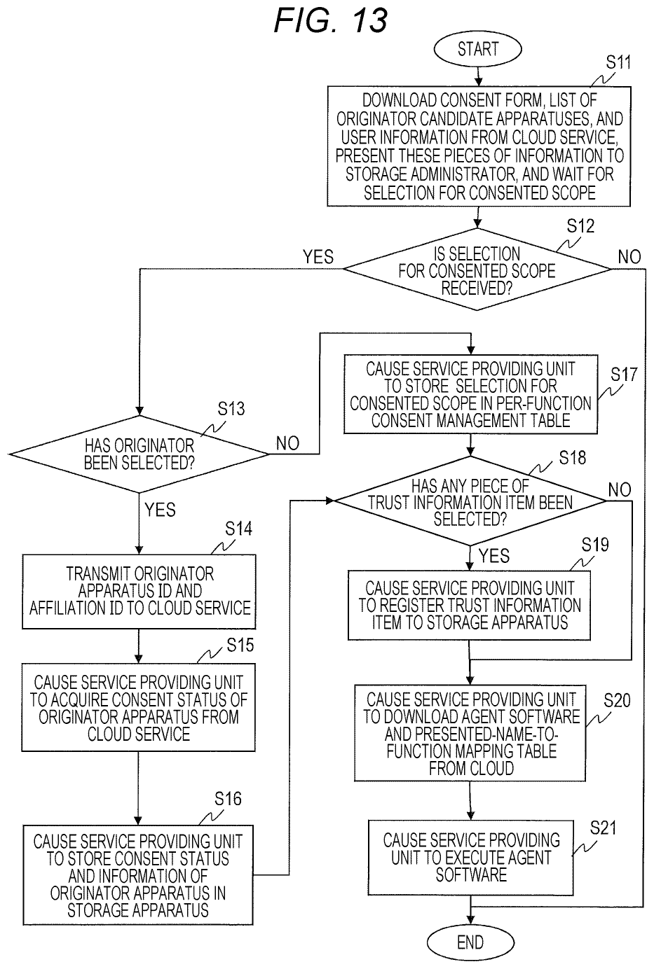

FIG. 13 illustrates an example of a trust information setting sequence in a storage apparatus 3. The storage management service 30 on the storage apparatus 3 downloads a consent form, a list of originator candidate storage apparatuses, and the user information (trust information), from the cloud service 1, presents these pieces of information to the storage administrator (customer), and waits for a selection of the scope to be consented (S11).

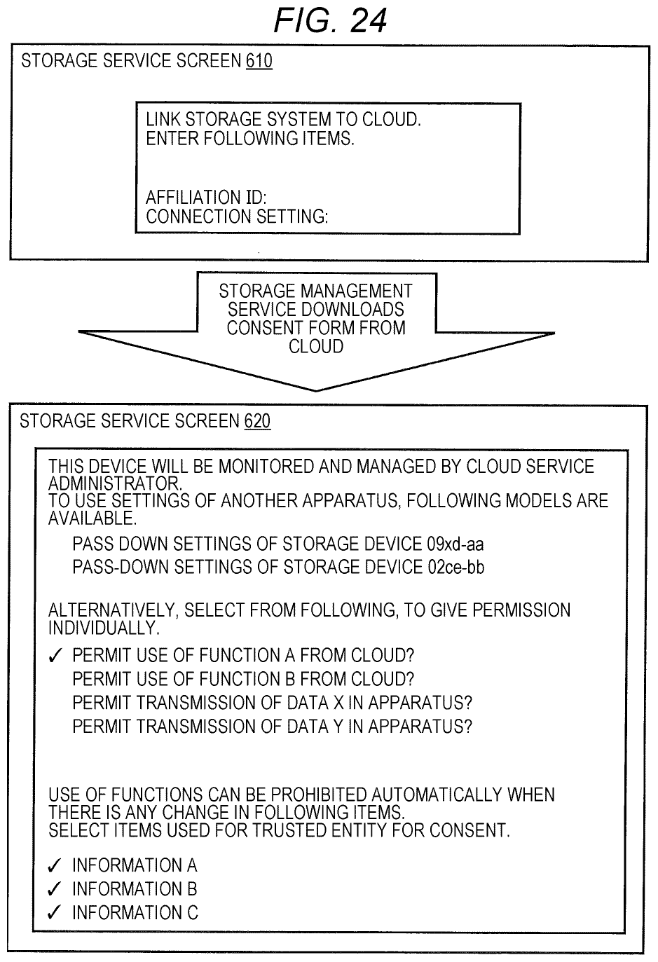

FIG. 24 illustrates an example of a service screen presented to the management terminal 6, by the storage management service 30. To begin with, the storage management service 30 presents the storage service screen 610. The storage service screen 610 prompts the storage administrator to enter information for establishing linkage with the cloud.

In the example illustrated in FIG. 24, the storage administrator enters the affiliation of the storage apparatus 3 and connection setting information for connecting to the cloud service 1. The affiliation of the storage apparatus 3 designates the organization where the storage apparatus 3 is managed, and the connection setting is setting information, such as proxy setting, required in communication over the Internet.

The storage management service 30 then downloads information including the consent form from the cloud service (S11), and presents a storage service screen 620 to the storage administrator on the management terminal 6. In the example illustrated in FIG. 24, the storage service screen 620 presents one example of the consent form. Note that the consent form to be consented may be generated either by the cloud service 1 or the storage management service 30, and the consent form generated by the cloud service 1 may include all of the information needing to be transmitted.

The consent form included the storage service screen 620 presents an originator list that is a list of storage apparatuses from which function consent settings can be passed down (a list of originator candidate storage apparatuses), a list of functions to be given the permission to use are individually selectable, and a list of items of trust information (user information) a change of which triggers interruption in the use of the function.

The storage service screen 620 presents two storage apparatuses “09xd-aa” and “02ce-bb” that are permitted to pass down the consented scope, but none of these storage apparatuses are selected. The storage apparatuses presented as candidates for the originator are, for example, a storage apparatus having the same affiliation and already given a setting (consent) for the use of the functions. Four functions that are individually selectable are also presented, and the function A is selected as a function that can be used over the cloud service 1. Note that the executed function may be presented, instead of or in addition to the name of the function used in the consent form.

In the list of the trust information items, all of the information items are selected. The information A, the information B, and the information C correspond to the information managed in the user information table 540 or the trust information setting 360. When there is a change in any of the selected items, the use of designated functions of the agent software 31 is interrupted.

The items selected from the consent form on the storage service screen 620, that is, the information on the consent given for the use of the functions and the information on the selection of the trust information items are stored in the per-function consent management table 320 and the trust information setting 360 in the storage apparatus, respectively.

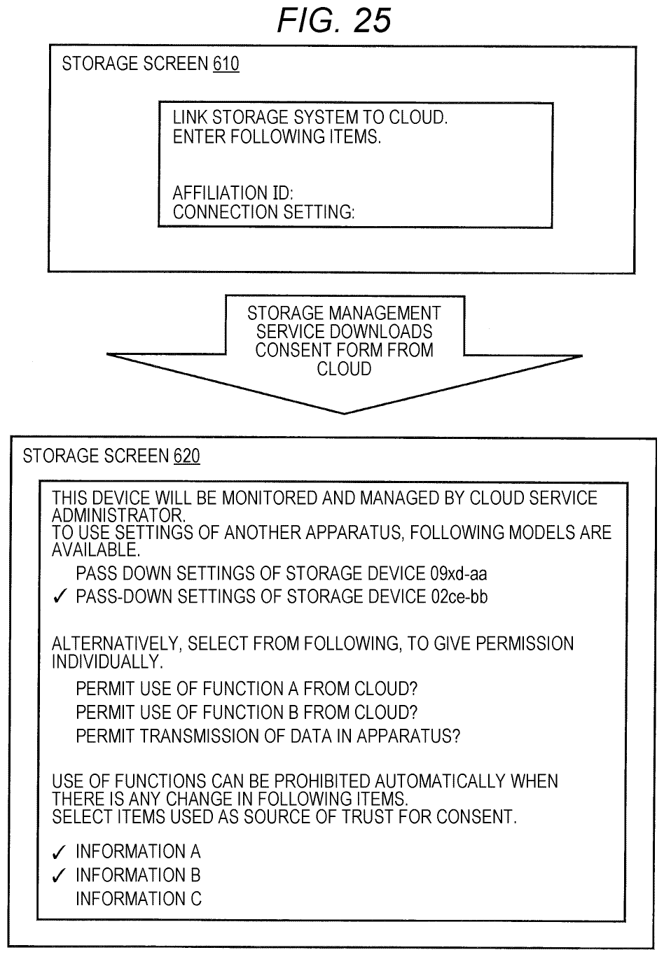

FIG. 25 illustrates another example of the service screen presented to the management terminal 6 by the storage management service 30. As compared with the example illustrated in FIG. 24, different items are selected in the consent form by the storage administrator on the storage service screen 620. The storage service screen 610 is the same as the storage service screen 610 illustrated in FIG. 24.

In the consent form on the storage service screen 620, an originator storage apparatus is selected, instead of the function of the agent software 31. In addition, the information A and the information B are selected as the trust information item triggering a change in the permission for using the functions, and the information C is excluded. In the same manner as the example illustrated in FIG. 24, the information of the items selected in the consent form on the storage service screen 620 is stored in the per-function consent management table 320, the consent pass-down setting 350, and the trust information setting 360 in that storage apparatus.

Referring back to FIG. 13, in step S12, the storage management service 30 determines whether a selection of the scope to be consented for the use of the functions by the cloud service 1 has been received from the storage administrator. If the storage management service 30 fails to receive a selection of the consented scope (S12: NO), this sequence is ended.

If the storage management service 30 receives a selection of the consented scope (S12: YES), the storage management service 30 determines whether the originator storage apparatus from which the consented scope is passed down has been selected (designated) by the storage administrator (S13). If the originator has been selected (S13: YES), the storage management service 30 transmits the originator storage apparatus ID designated by the storage administrator and the received affiliation ID to the cloud service 1 (S14).

The management service providing unit 301 then acquires the consent status of the originator storage apparatus from the cloud service 1. The consent status of the storage apparatus is managed in the consent status table 530 in the cloud service device 10.

The management service providing unit 301 then stores the consent status of the originator and the information of the originator storage apparatus in the storage apparatus 3. Specifically, the management service providing unit 301 stores the consented scope in the per-function consent management table 320, and stores the ID of the originator storage apparatus in the consent pass-down setting 350.

If no originator is selected in step S13 (S13: NO), the management service providing unit 301 stores the selections for the consented scope in the per-function consent management table 320 (S17).

Subsequently to step S16 or S17, the storage management service 30 determines whether any of the trust information items has been selected by the storage administrator (S18). If any item of the trust information has been selected (S18: YES), the management service providing unit 301 registers the trust information item in the storage apparatus 3. Specifically, the selected item is registered in the trust information setting 360.

The management service providing unit 301 downloads the agent software binary 310 and the presented-name-to-function mapping table 330 from the cloud service 1 (S20), and executes the agent software 31 (S21). Note that it is also possible for the storage administrator to be presented with only one of the designation as to whether to give each function the permission to use, and a pass-down setting of the consented scope from another storage apparatus 3.

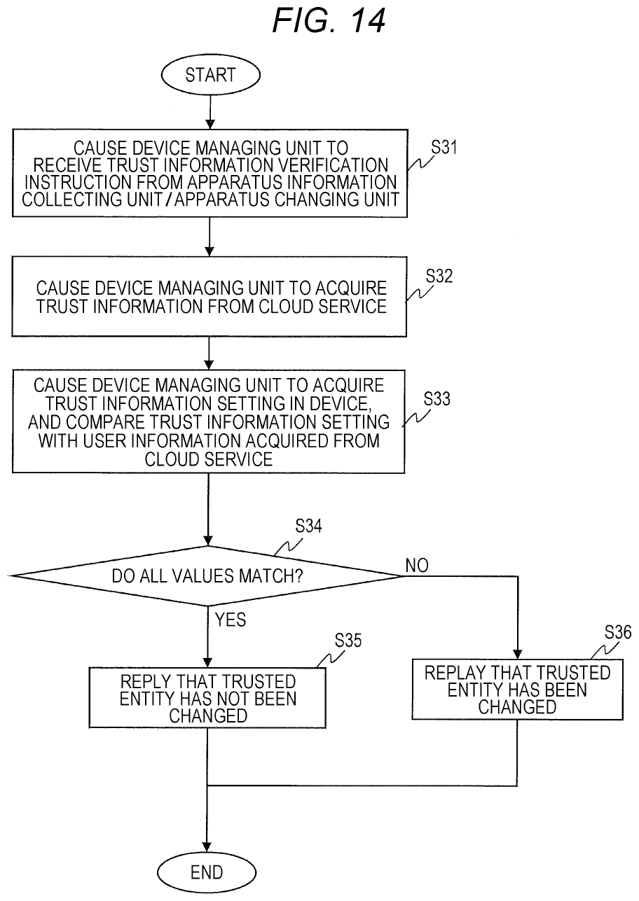

FIG. 14 illustrates an example of a trust information verification sequence in the storage apparatus 3. The trust information verification sequence executed in some of the processes to be described later. In the trust information verification sequence, it is determined whether the cloud service 1 via which the service is used is trustable.

To begin with, the device managing unit 311 receives a trust information verification instruction from the apparatus information collecting unit 313 or the apparatus changing unit 312 (S31). The apparatus information collecting unit 313 or the apparatus changing unit 312 is a program causing the agent software 31 to perform a function to the cloud service 1.

The device managing unit 311 acquires the trust information of the cloud service from the cloud service 1 (S32). The trust information is stored in the user information table 540 in the cloud service device 10.

The device managing unit 311 acquires the trust information setting 360 that is locally stored in the storage apparatus 3, compares the trust information setting 360 with the user information (trust information) acquired from the cloud service 1 (S33), and determines whether every value matches (S34). If every value matches (S34: YES), the device managing unit 311 makes a reply that there is no change in the trusted entity (S35). If there is any value that does not match (S34: NO), the device managing unit 311 makes a reply that there has been a change in the trusted entities (S36).

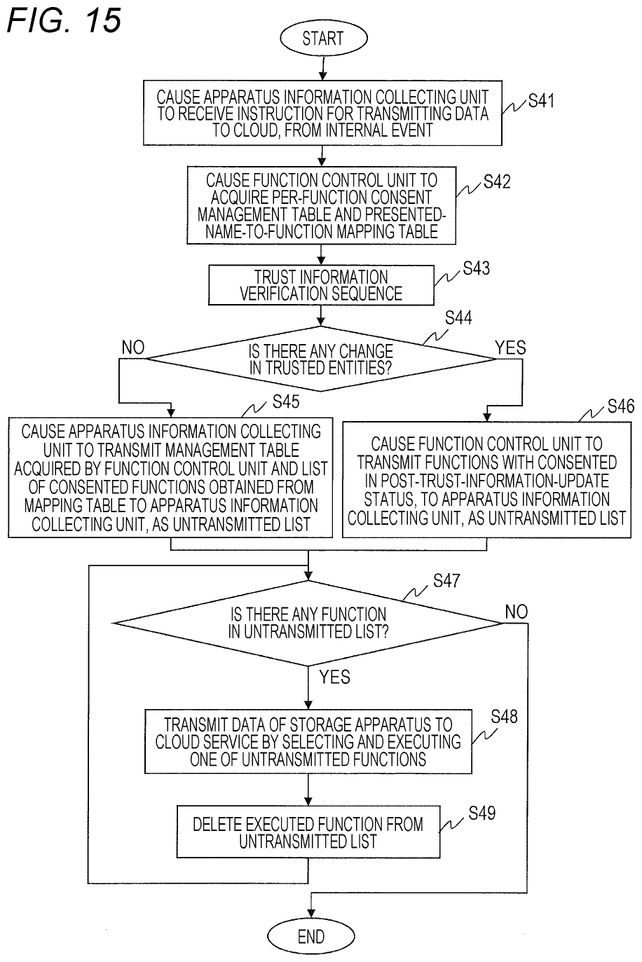

FIG. 15 illustrates an example of a sequence of a process of transmitting storage apparatus data from the storage apparatus 3 to the cloud service 1. This process of transmitting data to the cloud is an example of a process performed by a function executed for the cloud service 1 by the agent software 31, and is usually triggered by an internal event in the storage. It is herein assumed that one or more storage apparatus data transmission functions having different IDs transmit different types of data (such as a temperature and a CPU load).

The apparatus information collecting unit 313 receives an instruction for transmitting data to the cloud from an internal event in the storage apparatus 3 (S41). The function control unit 314 then acquires the per-function consent management table 320 and the presented-name-to-function mapping table 330 (S42).

In response to the instruction from the apparatus information collecting unit 313, the device managing unit 311 is caused to execute the trust information verification sequence (S43). The apparatus information collecting unit 313 refers to the result of the trust information verification sequence, and determines whether there has been any change in the trusted entities (S44).

If there is no change in the trusted entities (S44: NO), the function control unit 314 transmits a list of consented functions as an untransmitted list to the apparatus information collecting unit 313, on the basis of the acquired per-function consent management table 320 and presented-name-to-function mapping table 330 (S45). If there is some change in the trusted entities (S44: YES), the function control unit 314 transmits the functions with CONSENTED specified in the post-trust-information-update status field 325, to the apparatus information collecting unit 313, as the untransmitted list (S46).

The apparatus information collecting unit 313 determines whether there is any function in the untransmitted list (S47). If there is a function in the untransmitted list (S47: YES), the apparatus information collecting unit 313 selects and executes one of the untransmitted functions, and transmits the data of the storage apparatus 3 to the cloud service 1 (S48), and deletes the executed function from the untransmitted list (S49). The sequence goes back to step S47. If there is no function in the untransmitted list in step S47 (S47: NO), this sequence is ended.

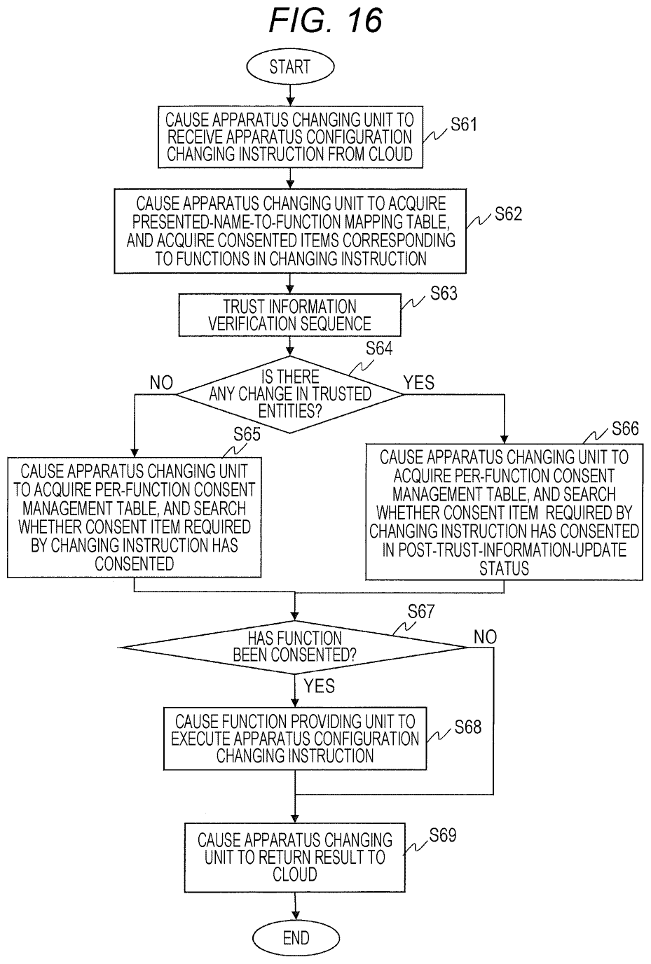

FIG. 16 illustrates an example of a sequence of a storage apparatus changing process. This storage apparatus changing process is an example of a process performed by a function executed for the cloud service 1 by the agent software 31. The apparatus changing process is a process of changing a configuration (including a volume configuration) of the storage apparatus, and usually is triggered by an instruction from the cloud service 1.

To begin with, the apparatus changing unit 312 receives an apparatus configuration changing instruction from the cloud service 1 (S61). This apparatus configuration changing instruction is an instruction for changing the configuration of the storage apparatus 3. The apparatus changing unit 312 acquires the presented-name-to-function mapping table 330, and acquires the consented item corresponding to the function in the changing instruction (S62).

In response to the instruction from the apparatus changing unit 312, the device managing unit 311 is caused to executes the trust information verification sequence (S63). The apparatus changing unit 312 refers to the result of the trust information verification sequence, and determines whether there has been any change in the trusted entities (S64).

If there is no change in the trusted entities (S64: NO), the apparatus changing unit 312 acquires the per-function consent management table 320, and searches whether the consented item required by the changing instruction has CONSENTED in the current status field 324 (S65). If there is any change in the trusted entities (S64: YES), the apparatus changing unit 312 acquires the per-function consent management table 320, and searches whether the consented item required by the changing instruction has CONSENTED in the post-trust-information-update status field 325 (S66).

The apparatus changing unit 312 determines whether the changing instruction corresponds to a function having been already consented (S67). If the changing instruction does not correspond to a function having been already consented (S67: NO), the apparatus changing unit 312 returns the result to the cloud service 1 (S69). If the instruction corresponds to a consented function (S67: YES), the function providing unit 121 executes the apparatus configuration changing instruction (S68). The apparatus changing unit 312 then returns the result to the cloud service 1 (S69).

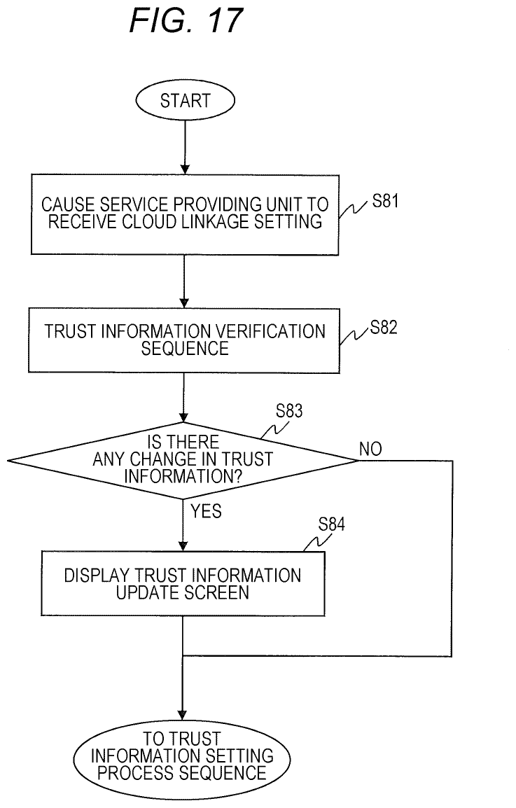

FIG. 17 illustrates an example of a sequence of a trust information updating process. For example, the cloud service 1 notifies the agent software 31 of the information on which the trust is based, regularly or at the time when there is an update in the information.

The management service providing unit 301 receives a cloud linkage setting from the cloud service 1 (S81). In response to the instruction from the management service providing unit 301, the device managing unit 311 is caused to execute the trust information verification sequence (S82). The management service providing unit 301 refers to the result of the trust information verification sequence, and determines whether there has been any change in the trust information (S83). If there is no change (S83: NO), this sequence is ended. If there is any change (S83: YES), the device managing unit 311 displays a trust information updating screen (S84). The sequence follows the trust information setting sequence described with reference to FIG. 13.

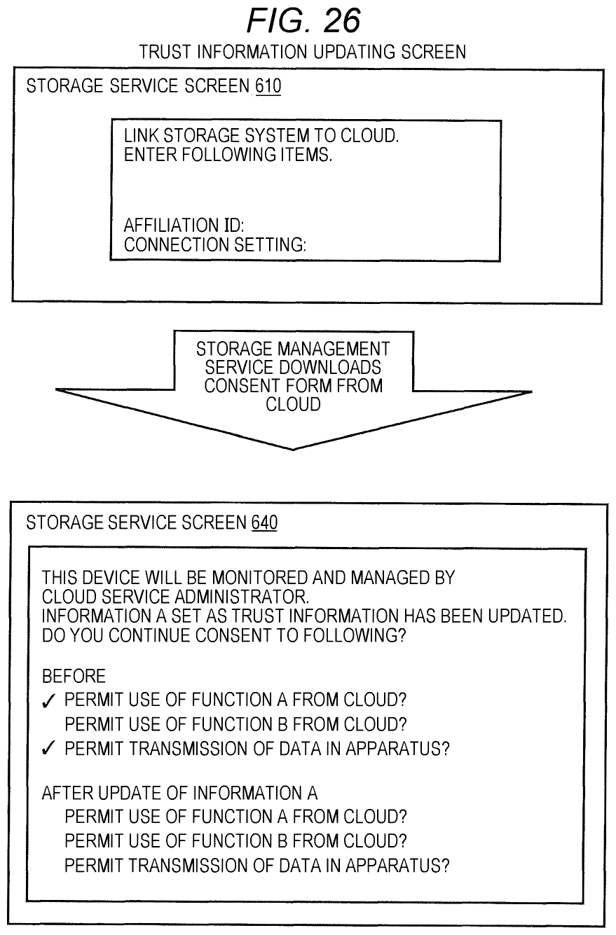

FIG. 26 illustrates an example of the trust information updating screen. The screen 610 is as described with reference to FIG. 24 or 25. The consent form on the screen 640 presents consents of the storage administrator on the use of the functions, when there is a change in the trust information. In the example of FIG. 26, the screen 610 notifies the storage administrator that the information A in the trust information has been updated, and requests the storage administrator to reselect the functions to give a consent for use, accordingly. The function A and the data transmitting function have been selected before the update of the trust information. The storage administrator selects a function to give a permission for use subsequently to the update of the information A. When the consent form is applied, the selected item is registered to the per-function consent management table 320 in the storage apparatus.

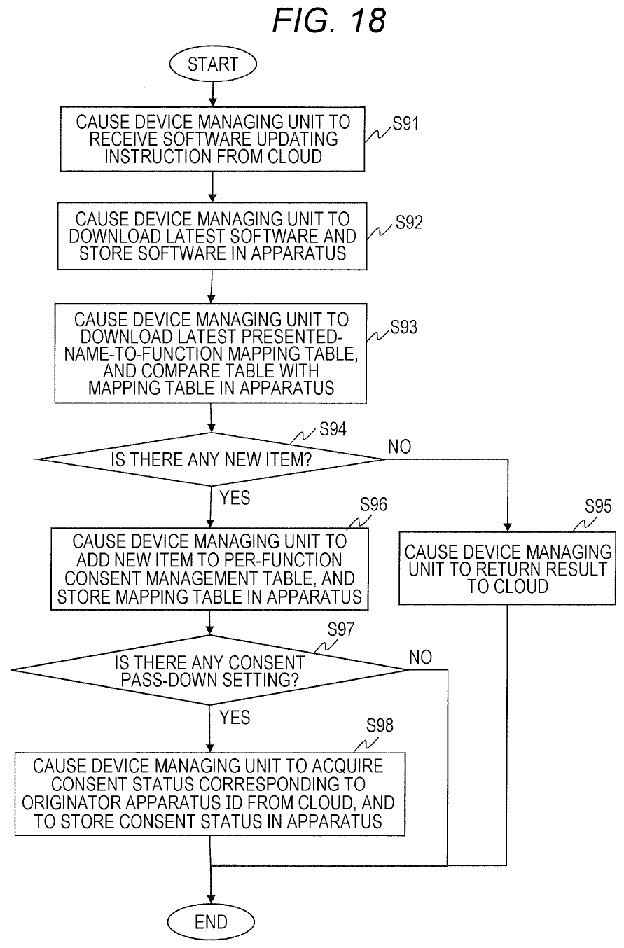

FIG. 18 illustrates an example of an agent software updating sequence in the storage apparatus 3. In an embodiment of the present disclosure, the agent software 31 is kept updated to the latest version, through a cooperation with the cloud service 1. In this manner, updates satisfying minimum requirements, such as defect fix or a security patch not requiring any consent can be applied in a timely fashion. At the same time, the storage administrator can impose restrictions to the functions, because the functions are restricted in accordance with the consented scope.

To begin with, the device managing unit 311 receives a software updating instruction from the cloud service 1 (S91). The device managing unit 311 downloads the latest agent software from the cloud service 1, and stores the agent software in the storage apparatus 3 (S92).

The device managing unit 311 downloads the latest presented-name-to-function mapping table from the cloud service 1, and compares the table with the presented-name-to-function mapping table 330 in the storage apparatus 3 (S93). If the table does not have any new item (S94: NO), the device managing unit 311 returns a result indicating UPDATED to the cloud service 1 (S95), and the sequence is ended.

If a new item is included in the table (S94: YES), the device managing unit 311 adds the new item to the per-function consent management table 320, and stores the latest presented-name-to-function mapping table 330 in the storage apparatus 3 (S96).

The device managing unit 311 determines whether there is any consent pass-down setting 350 in the storage apparatus (S97). If there is a consent pass-down setting 350 (S97: YES), the device managing unit 311 acquires the consent status corresponding to the originator apparatus ID from the cloud service 1, stores the consent status in the storage apparatus 3 (S98), and the sequence is ended. If there is no consent pass-down setting 350 (S97: NO), step S98 is skipped, and the sequence is ended.

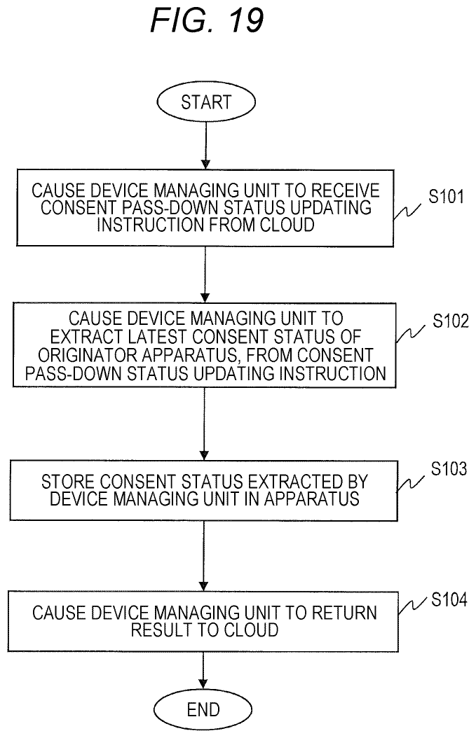

FIG. 19 illustrates an example of a consent pass-down status updating sequence in the storage apparatus 3. The device managing unit 311 receives a consent pass-down status updating instruction from the cloud service 1 (S101). The device managing unit 311 extracts the latest consent status of the originator apparatus from the consent pass-down status updating instruction (S102). The device managing unit 311 stores the extracted consent status in the storage apparatus 3 (S103). The device managing unit 311 returns the result to the cloud service 1 (S104).

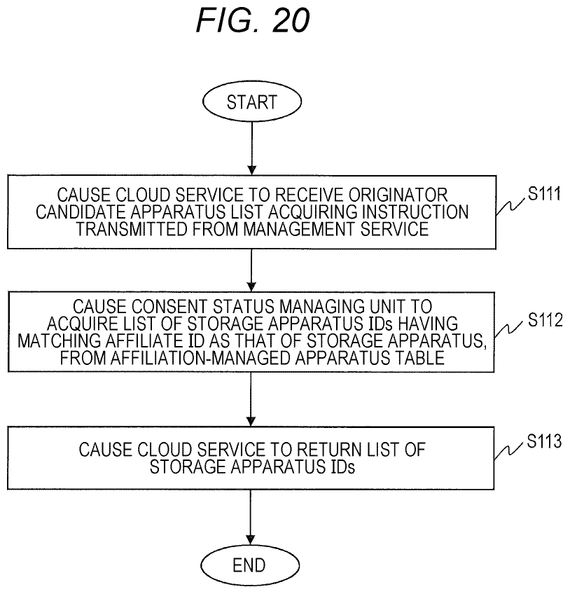

Processing performed by the cloud service 1 will now be described. FIG. 20 illustrates an example of an originator candidate apparatus list providing sequence in the cloud service 1. This process relates to, for example, step S11 in the trust information setting sequence illustrated in FIG. 13.

The cloud service 1 receives an originator candidate list acquiring instruction from the management service providing unit 301 (S111). The user data collecting unit 101 acquires a list of storage apparatus IDs having the same affiliation IDs as the storage apparatus 3, from the affiliation-managed apparatus table 510 (S112). The IDs from which the list is acquired may be limited to the IDs registered in the consent status table 530. The cloud service 1 returns the acquired list of the storage apparatus IDs to the storage apparatus 3 (S113).

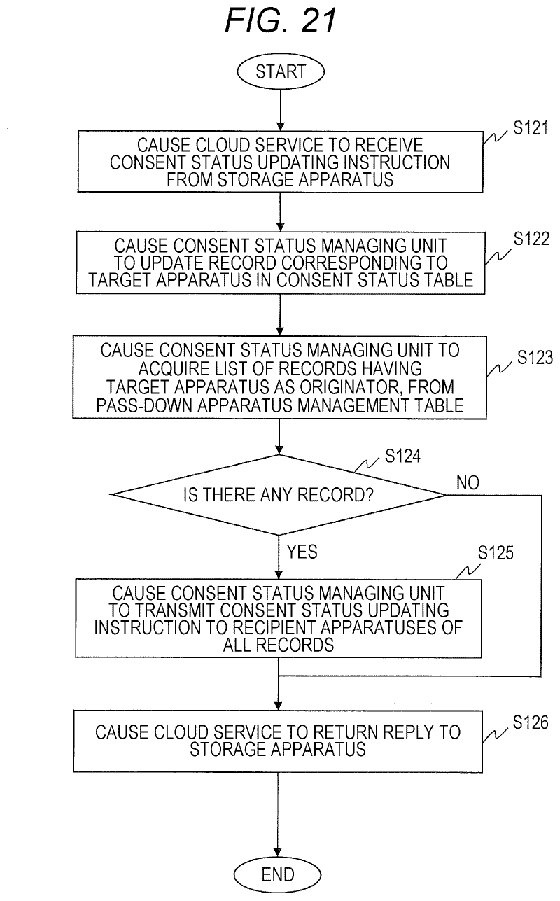

FIG. 21 illustrates an example of a consent status changing sequence in the cloud service 1. The cloud service 1 receives a consent status updating instruction from the storage apparatus 3 (S121). The consent status managing unit 102 updates the record corresponding the target storage apparatus 3 in the consent status table 530 (S122).

The consent status managing unit 102 acquires a list of records having the target apparatus as the originator, from the pass-down apparatus management table 520 (S123). If there is no record (S124: NO), this sequence is ended. If there is some record (S124: YES), the consent status managing unit 102 transmits a consent status updating instruction to all of the recipient apparatuses specified in the record (S125). The cloud service 1 then returns a response to the storage apparatus 3 (S126).

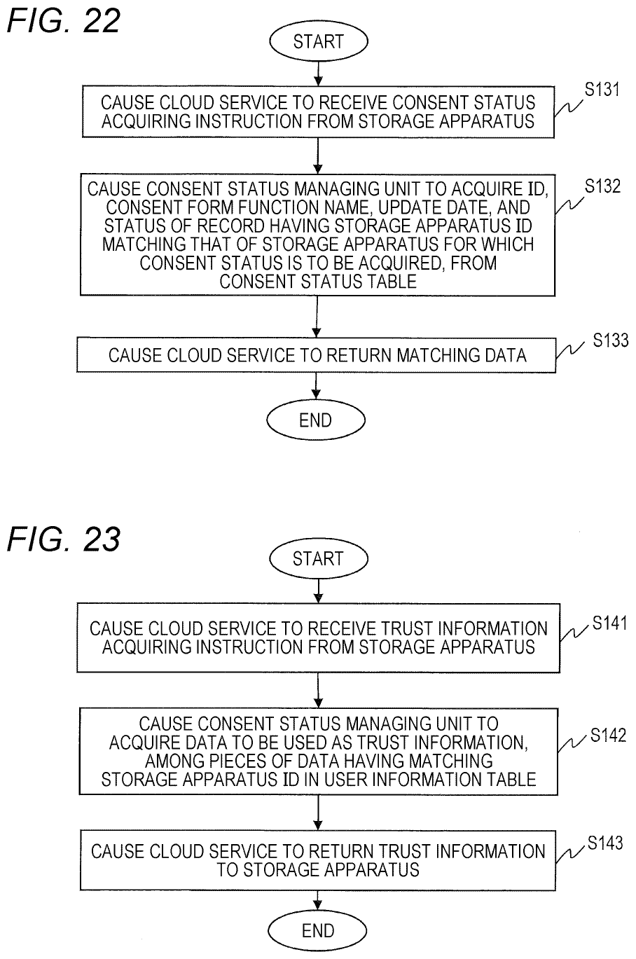

FIG. 22 illustrates an example of a consent status providing sequence in the cloud service 1. This process is related to, for example, the trust information setting sequence illustrated in FIG. 13. The cloud service 1 receives a consent status acquiring instruction from the storage apparatus 3 (S131). The consent status managing unit 102 acquires the ID, the consent form function name, the update date, and the status of a record having a storage apparatus ID matching that of the storage apparatus of which the consent status is to be acquired, from the consent status table 530 (S132). The cloud service 1 then returns the matching data (S133).

FIG. 23 illustrates an example of a trust information providing sequence in the cloud service 1. This process is related to, for example, the trust information verification sequence illustrated in FIG. 14. The cloud service 1 receives a trust information acquiring instruction from the storage apparatus 3 (S141). The consent status managing unit 102 acquires the data to be used as the trust information, among the pieces of data having a matching storage apparatus ID in the user information table 540 (S142). The cloud service 1 then returns the trust information to the storage apparatus (S143).

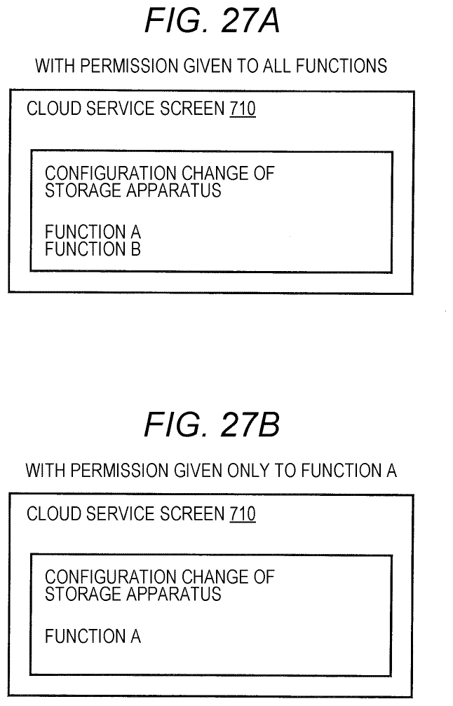

FIGS. 27A and 27B illustrate examples of a cloud service screen 710 presented to the user by the cloud service 1. In one embodiment of the present disclosure, the cloud service 1 refers to the consent status table 530, and presents only the functions of the storage apparatus 3 (agent software 31) that users are given a consent for use, in a selectable manner.

In FIGS. 27A and 27B, the cloud service screen 710 presents only the functions that the users are permitted to use, among the functions pertinent to a configuration change in the storage apparatus. In the example illustrated in FIG. 27A, the consent for use is given only for the function A and the function B. In the example illustrated in FIG. 27B, the consent for use is given only for the function A. In this manner, by presenting only the functions the users are given a consent for the use, in a selective manner, it is possible to improve the efficiency of the subsequent process.

Note that the present invention is not limited to the embodiments described above, and includes various modifications thereof. For example, because the embodiment has been explained above in detail to facilitate understanding of the present invention, the present invention is not necessarily limited to the configuration including all of the elements explained above. Furthermore, a part of the configuration according to one embodiment may be replaced with a configuration according to another embodiment, and a configuration according to another embodiment may be added to the configuration of the one embodiment. In addition, another configuration may be added to, deleted from, and replaced with a part of the configuration according to each of the embodiments.

In addition, some or all of the configurations, functions, and the like explained above may be implemented as hardware, through designing of an integrated circuit, for example. In addition, each of the configurations, functions, and the like explained above may be implemented as software by causing a processor to parse and to execute a computer program for implementing the corresponding function. Information such as a computer program, a table, and a file for implementing each of the functions may be stored in a recording device such as a memory, a hard disk, or a solid state drive (SSD), or a recording medium such as an IC card or an SD card.

In addition, control lines and information lines presented are those considered to be necessary for the explanation, and are not necessarily the representations of all of the control lines and the information lines in the product. In reality, it is possible to consider that almost all of the configurations are connected to one another.

What is claimed is:

1. An apparatus for providing a management function, the apparatus comprising:
a processor; and
a memory device,
wherein the memory device stores agent software capable of executing a plurality of the management functions of the apparatus, and also stores consent information indicating whether use of each of the plurality of management functions is permitted, and
the processor executes a management function use of which is permitted by the consent information, among the plurality of management functions, rejects execution of a management function use of which is prohibited by the consent information, and updates the agent software without obtaining a consent of an administrator of the apparatus.

2. The apparatus according to claim 1, wherein
the processor receives a designation pertinent to the consent information from the administrator, and
the consent information specifies whether use of each of the plurality of management functions is permitted, in accordance with the designation from the administrator.

3. The apparatus according to claim 1, wherein the processor reflects a consented scope of another apparatus that has been designated in advance, to the consent information.

4. The apparatus according to claim 3, wherein
the processor transmits a designation of the other apparatus to a service device,
the service device manages consent information of a plurality of apparatuses, and
the processor receives a consented scope of the other apparatus from the service device and reflects the consented scope to the consent information.

5. The apparatus according to claim 3, wherein, when there is a change in the consented scope of the other apparatus, the processor reflects the change in the consented scope, to the consent information.

6. The apparatus according to claim 1, wherein
the memory device stores trust information,
the trust information includes information of a user of the plurality of management functions,
the consent information includes information on whether use of each of the plurality of management functions subsequent to a change in the trust information is to be permitted, and
the processor executes, in response to a change in the trust information, a function use of which subsequent to a change in the trust information is permitted by the consent information, and rejects execution of a management function use of which subsequent to a change in the trust information is prohibited by the consent information.

7. A system comprising:
the apparatus according to claim 1; and
a service device,
wherein the service device retains the consent information, and
the service device controls use of the plurality of management functions by a user, in accordance with the consent information.

8. The system according to claim 7, wherein the service device excludes a management function use of which is prohibited by the consent information, from a display for allowing the user to make a selection.

9. A method by which an apparatus for providing a management function controls the management function, wherein
the apparatus stores:
agent software capable of executing a plurality of the management functions of the apparatus; and
consent information indicating whether use of each of the plurality of management functions is permitted,
the method comprising causing the apparatus to:
execute a management function use of which is permitted by the consent information;
reject execution of a management function use of which is prohibited by the consent information; and
update the agent software without obtaining a consent of an administrator of the apparatus.
